(19) United States
(12) Patent Application Publication
(10) Pub. No.: US 2016/0297055 A1
(43) Pub. Date: Oct. 13, 2016

(54) METHOD FOR MAKING BICYTCLE FOLDING TOOL OF BICYCLE

(71) Applicant: Tuo-Jen Chen, Taichung City (TW)

(72) Inventor: Tuo-Jen Chen, Taichung City (TW)

(21) Appl. No.: 14/684,442

(22) Filed: Apr. 13, 2015

(51) Int. Cl. B25B 15/00; B23P 13/00

(52) U.S. Cl. CPC B25B 15/001; B23P 13/00

(57) ABSTRACT

A method for making a folding tool includes a step of preparing a bar with a hexagonal cross section, a rectangular cross section or a circular cross section; a step of cutting the bar into a base with a pre-set length; a step of trimming two surfaces of a first end and a second end of the base to form a semi-finished product; a step of forming a working end at a first end of the semi-finished product by way of lathing and milling; a step of forming a connection end at a second end of the semi-finished product by way of milling, and a step of forming a hole through the connection end by way of drilling or milling.

### BACKGROUND OF THE INVENTION

1. Fields of the Invention

The present invention relates to a method for making a bicycle folding tool, and more particularly, to a method for making a bicycle folding tool without heat treatment.

2. Descriptions of Related Art

The conventional method for making a bicycle folding tool is to machine one end of a bar into a working end, and the other end of the bar is bent to form a hole. The cross section of the bar is a equal-sided polygonal cross section or a round cross section. The working end is machined by using a co-axial lathe so as to manufacture the folding tools in mass production. The bar includes a section with the length “L” as shown in FIG. 1, the section is to be bent to form the hole. Therefore, the conventional folding tool needs a lot of material and the weight is significant.

One of the known methods is to forge the bar to have desired shape, however, this method will leave accumulated stress to the bar and makes the bar to be fragile. Therefore, a annealing process is need to make the bar to be softer such that the following steps such as pressing and cutting can be applied to the semi-finished product.

The steps of pressing and forging can make a compact tool with proper strength, nevertheless, the step of annealing may cause de-carbonization which makes the product to have less strength after being treated with heat treatment. This shortcoming is especially obvious for small tools. Also, the manufacturing cost is high.

Another conventional method is disclosed in FIGS. 2 and 3, before bending one end of the bar, the end is pressed to have elastically deformation and surplus material is removed. Although the strength of this end is better than the product of the previous method, the stress left in the bent end is hardened in the further manufacturing steps. The hardened end of the bar is easily broken when bending the end into a hole.

Furthermore, the bent end with the hole which actually is a C-shaped hole which is not an enclosed hole, it cannot bear high torque.

The present invention intends to provide a method for making a bicycle folding tool without heat treatment, such that the shortcomings mentioned above are improved.

### SUMMARY OF THE INVENTION

The present invention relates to a method for making a folding tool, and the method comprises a step of preparing a bar with a hexagonal cross section, a rectangular cross section or a circular cross section; a step of cutting the bar into a base with a pre-set length; a step of trimming two surfaces of a first end and a second end of the base to form a semi-finished product; a step of forming a working end at a first end of the semi-finished product by way of lathing and milling; a step of forming a connection end at a second end of the semi-finished product by way of milling, and a step of forming a hole through the connection end by way of drilling or milling.

Preferably, the step of forming a connection end further includes a step of removing surplus material.

Preferably, the step of forming a hole further includes a step of removing surplus material.

Preferably, the outer diameter of the connection end 13 is X, and the diameter of the hole 131 is Y, 0.35X≦Y≦0.65X.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of a conventional method for making a bicycle folding tool;

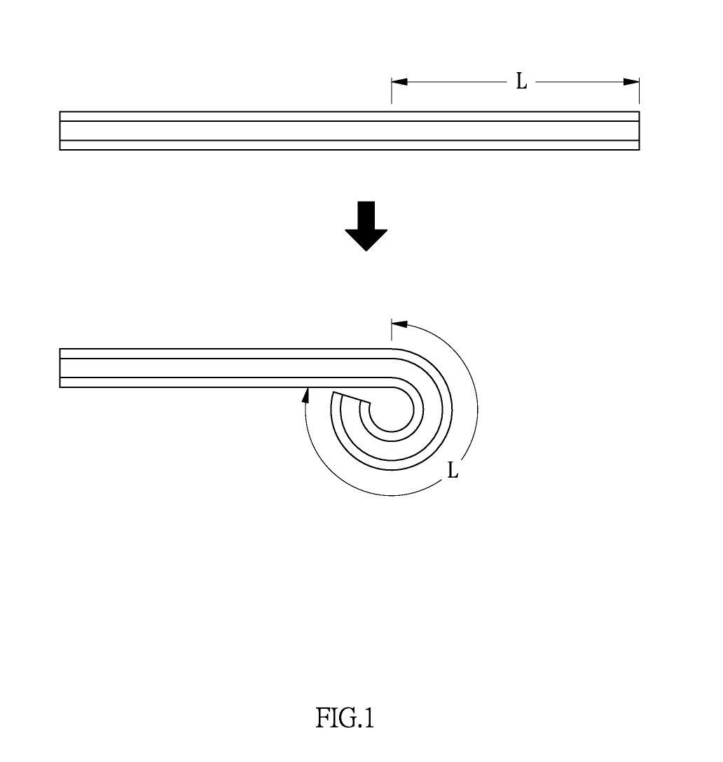

FIGS. 2 and 3 show the steps of a conventional method for making a bicycle folding tool;

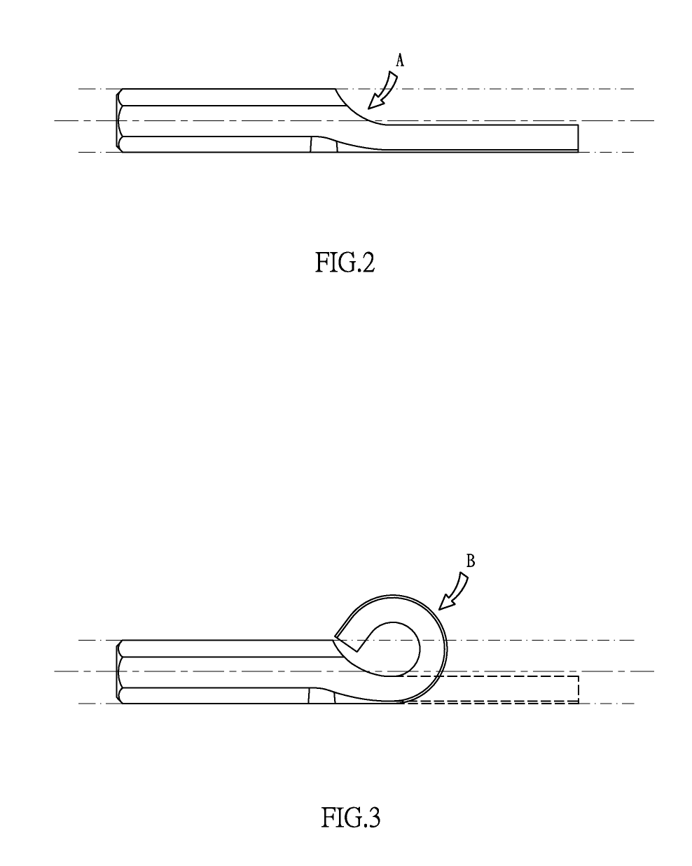

FIG. 4 shows the steps of the method of the present invention;

FIG. 5 shows the first step of the method of the present invention;

FIG. 6 shows the second step of the method of the present invention;

FIG. 7 shows the third step of the method of the present invention;

FIG. 8 shows the fourth step of the method of the present invention;

FIG. 9 shows the fifth step of the method of the present invention;

FIG. 10 shows the sixth step of the method of the present invention;

FIG. 11 shows that a step of removing surplus material is added in the fifth step of the present invention, and

FIG. 12 shows that a step of removing surplus material is added in the sixth step of the present invention.

### DETAILED DESCRIPTION OF THE PREFERRED EMBODIMENT

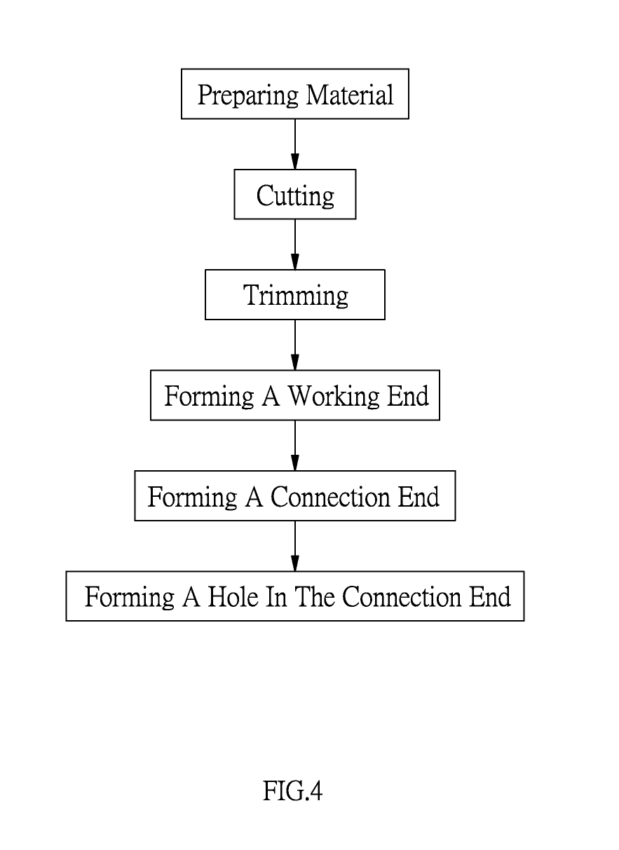

Referring to FIG. 4, the method of the present invention comprises the following steps:

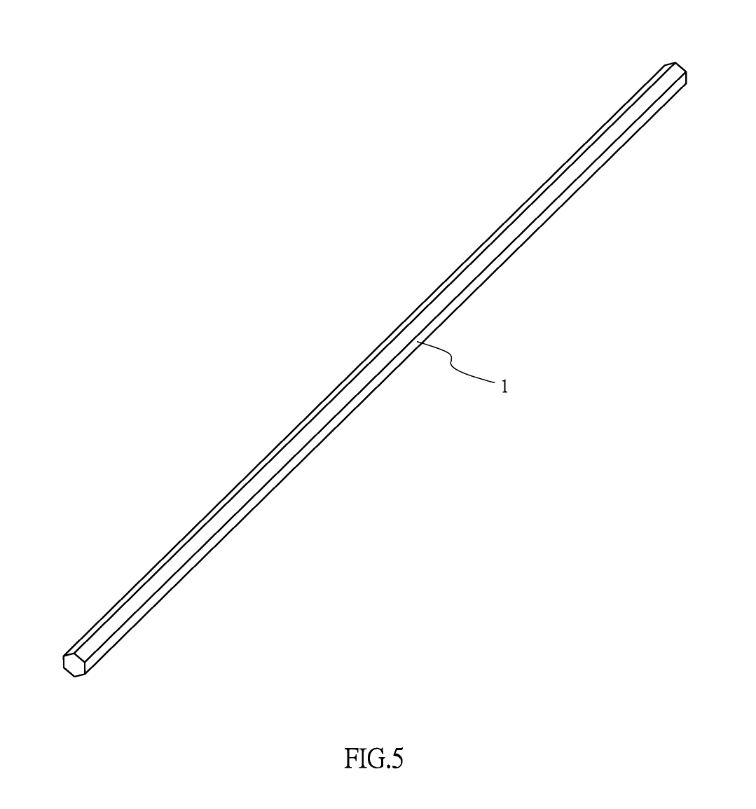

a step of preparing material: preparing a bar 1 which is a solid metal bar and has a hexagonal cross section, a rectangular cross section or a circular cross section as shown in FIG. 5;

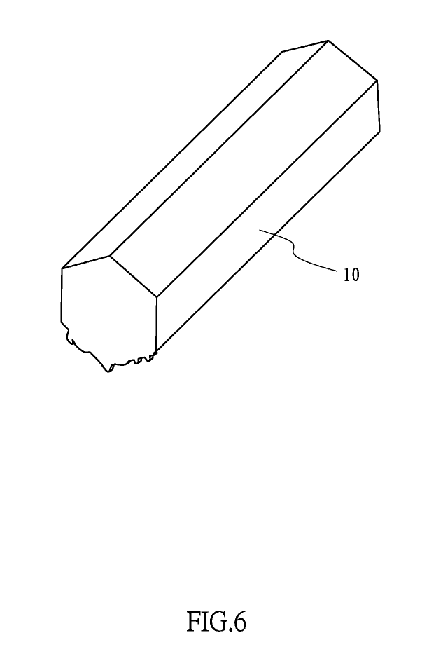

a step of cutting: cutting the bar 1 into a base 10 with a pre-set length as shown in FIG. 6;

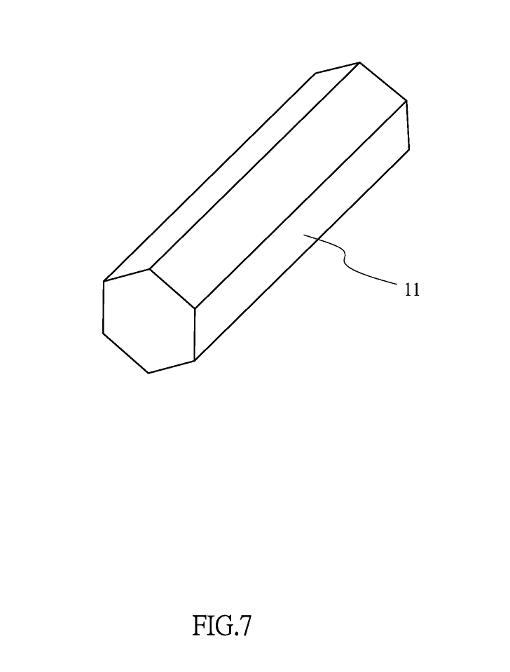

a step of trimming: trimming two end surfaces of a first end and a second end of the base 10 to form a semi-finished product 11 as shown in FIG. 7;

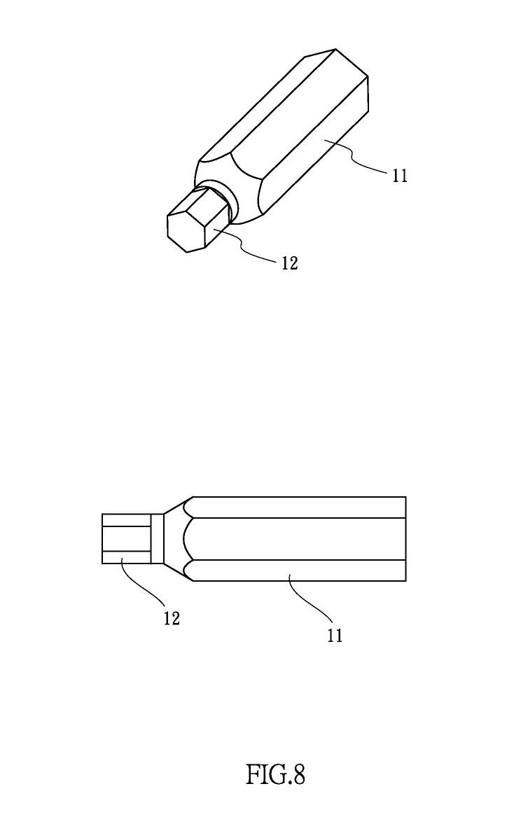

a step of forming a working end: lathing and milling a first end of the semi-finished product 11 to form a working end 12 as shown in FIG. 8;

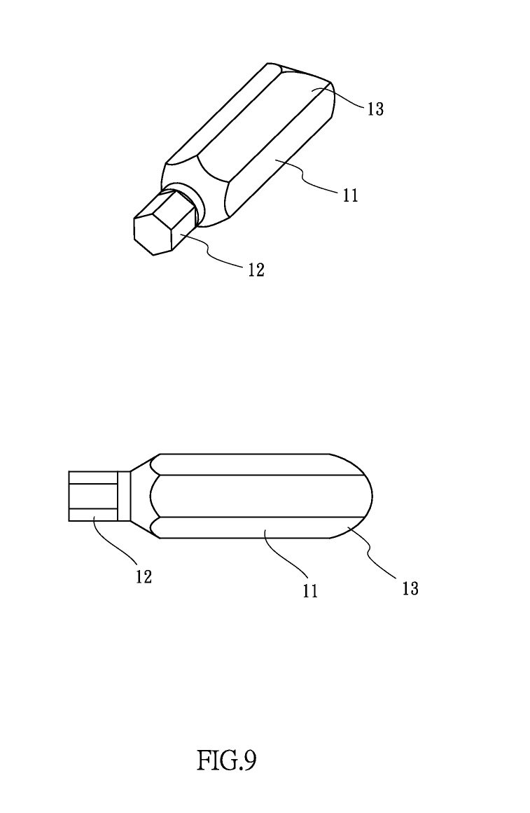

a step of forming a connection end: milling a second end of the semi-finished product 11 to form a connection end 13 as shown in FIG. 9, and

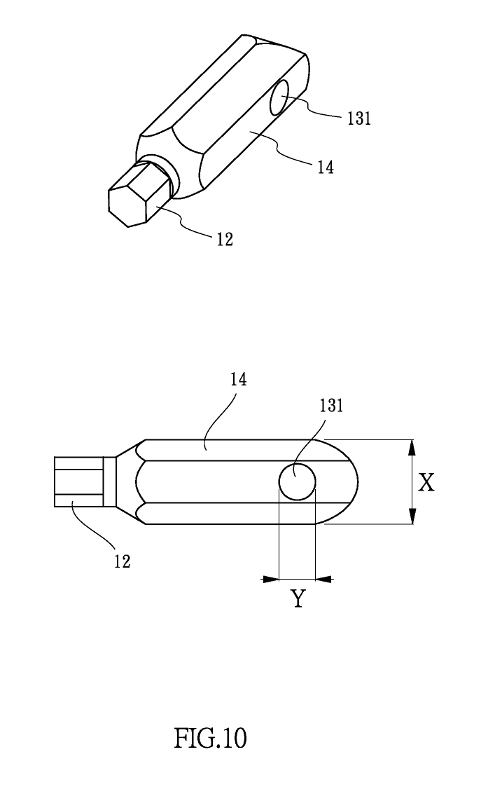

a step of forming a hole: drilling or milling an enclosed hole 131 through the connection end 13 to form the tool as shown in FIG. 10.

The hole 131 is an enclosed hole which has better strength and can bear high torque. The step of forming a hole is the final step so that there will be no extra machining step to be applied to the tool, the tool will not be deformed.

The semi-finished product is make from a bar wherein the sides are evenly separated so that the bar can be co-axially machined in mass production. The working end 12 has longer life time and the tool can be manufactured quickly. The manufacturing cost is low. The working end 12 can also be formed to be specific shape such as TORX box end or an open end. The bar 1 is conveniently purchased in the market.

The enclosed hole 131 is stronger than the C-shaped hole as disclosed in the conventional tool. The forming of the hole 131 is the final step, the connection end 13 will not be further machined so that the connection end 13 is not deform.

The method of the present invention does not need any step of annealing so that the manufacturing cost is low and the tool is made under a stable condition of the structure of the material.

The tool has a hole 131 in the connection end so as to be pivotably connected with a tool set.

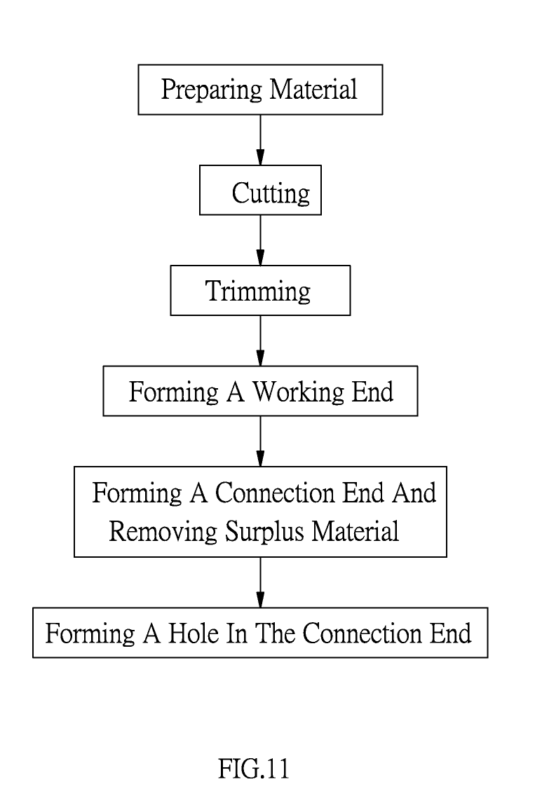

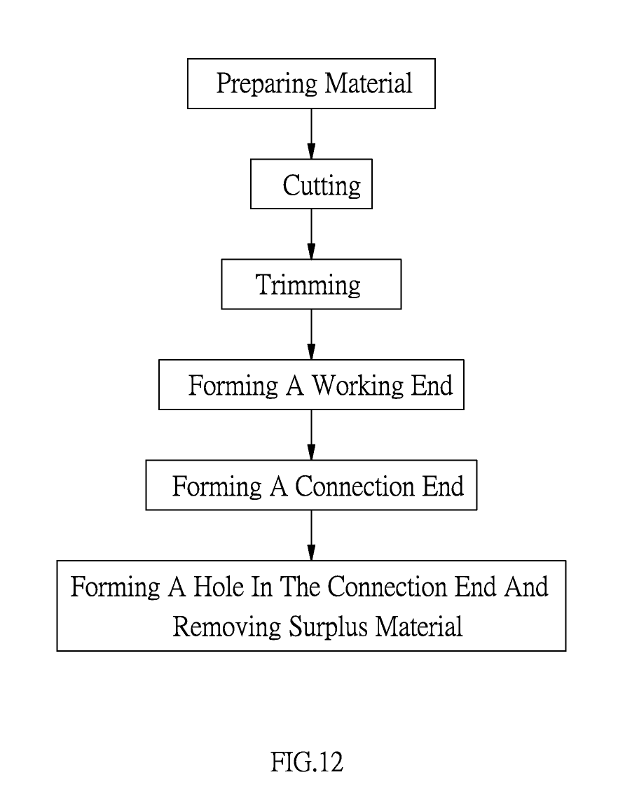

As shown in FIGS. 11 and 12, the step of forming a connection end further includes a step of removing surplus material, and the step of forming a hole further includes a step of removing surplus material.

As shown in FIG. 10, the outer diameter of the connection end 13 is X, and the diameter of the hole 131 is Y, 0.35X≦Y≦0.65X. Therefore, when pivotably connecting multiple tools to the folding tool set, the connection ends 13 of the tools do not interfere to each other.

While we have shown and described the embodiment in accordance with the present invention, it should be clear to those skilled in the art that further embodiments may be made without departing from the scope of the present invention.

What is claimed is:

1. A method for making a folding tool, comprising the following steps:
a step of preparing material: preparing a bar which has a hexagonal cross section, a rectangular cross section or a circular cross section;
a step of cutting: cutting the bar into a base with a pre-set length;
a step of trimming: trimming two end surfaces of a first end and a second end of the base to form a semi-finished product;
a step of forming a working end: lathing and milling a first end of the semi-finished product to form a working end;
a step of forming a connection end: milling a second end of the semi-finished product to form a connection end, and
a step of forming a hole: drilling or milling an enclosed hole through the connection end.

2. The method as claimed in claim 1, wherein the step of forming a connection end further includes a step of removing surplus material.

3. The method as claimed in claim 1, wherein the step of forming a hole further includes a step of removing surplus material.

4. The method as claimed in claim 1, wherein an outer diameter of the connection end is X, a diameter of the hole is Y, 0.35X≦Y≦0.65X.
